(19) United States
(12) Patent Application Publication
(10) Pub. No.: US 2026/0169596 A1
(43) Pub. Date: Jun. 18, 2026

(54) TOUCH SENSOR, DISPLAY DEVICE, METHOD FOR MANUFACTURING TOUCH SENSOR, AND METHOD FOR MANUFACTURING DISPLAY DEVICE

(71) Applicant: Sharp Display Technology Corporation, Kameyama City, Mie (JP)

(72) Inventors: Takao SAITOH, Kameyama City, Mie (JP); Yohsuke KANZAKI, Kameyama City, Mie (JP); Masaki YAMANAKA, Kameyama City, Mie (JP); Masahiko MIWA, Kameyama City, Mie (JP); Yi SUN, Kameyama City, Mie (JP); Masaki FUJIWARA, Kameyama City, Mie (JP); Kouhei KAMATANI, Kameyama City, Mie (JP)

(21) Appl. No.: 19/123,533

(22) PCT Filed: Oct. 31, 2022
(86) PCT No.: PCT/JP2022/040620

§ 371 Date: Apr. 23, 2025

(51) Int. Cl. G06F 3/044; G06F 3/041

(52) U.S. Cl. CPC G06F 3/044; G06F 3/0412; G06F 2203/04103; G06F 2203/04112

(57) ABSTRACT

A touch sensor includes: an insulating layer including a first portion having a thickness d1, a second portion having a thickness d2, and a third portion positioned between the first portion and the second portion, and having a thickness d3, wherein 0<d1−d3<d3−d2 is established; and a first wiring line positioned over the insulating layer, and overlapping the first portion in a plan view.

### TECHNICAL FIELD

The present disclosure relates to a touch sensor, a display device, and a method for manufacturing the touch sensor, and a method for manufacturing the display device.

### BACKGROUND ART

Patent Literature 1 discloses a method of manufacturing a liquid crystal display in which at least some of patterns on the same stacked surface parallel to a substrate undergo etching a plurality of times.

### CITATION LIST

### Patent Literature

Patent Literature 1: Japanese Unexamined Patent Application Publication No. 07-253593 (published on Oct. 3, 1995)

### SUMMARY

### Technical Problem

In such known techniques, dry etching to remove most of a conductive layer on an insulating layer involves increase in the amount of film loss of the insulating layer, unfortunately producing many residues of the conductive layer.

### Solution to Problem

A touch sensor according to one aspect of the present disclosure includes the following: an insulating layer including a first portion having a thickness d1, a second portion having a thickness d2, and a third portion positioned between the first portion and the second portion, and having a thickness d3, wherein 0<d1−d3<d3−d2 is established; and a first wiring line positioned over the insulating layer, and overlapping the first portion in a plan view.

A display device according to one aspect of the present disclosure includes the following: a display panel; and the touch sensor according to the aspect of the present disclosure.

A method for manufacturing a touch sensor according to one aspect of the present disclosure includes the following: forming an insulating layer; forming a conductive layer to cover the insulating layer; masking a provisional-geometry region of the conductive layer with a resist, followed by dry-etching a region other than the provisional-geometry region; and forming a first wiring line by masking, with a resist, a wiring region being a part of the provisional-geometry region, followed by dry-etching a region other than the wiring region.

A method for manufacturing a display device according to one aspect of the present disclosure includes the following: preparing a display panel including a plurality of emission regions; and forming a touch sensor onto the display panel by using the method for manufacturing the touch sensor according to the aspect of the present disclosure.

### Advantageous Effect of Disclosure

The aspects of the present disclosure enable residue reduction.

### BRIEF DESCRIPTION OF DRAWINGS

FIG. 1 is a plan view of an example configuration of a touch sensor according to one embodiment of the present disclosure.

FIG. 2 is a cross-sectional view of the example configuration of the touch sensor illustrated in FIG. 1, and is a cross-sectional view taken along line A-B in FIG. 1.

FIG. 3 is a cross-sectional view of the example configuration of the touch sensor illustrated in FIGS. 1 and 2, with attention focused on its first wiring line and insulating layer.

FIG. 4 is a flowchart showing an example method for manufacturing the touch sensor illustrated in FIGS. 1 to 3.

FIG. 5 is a cross-sectional view of the touch sensor illustrated in FIG. 4, in the process of being manufactured.

FIG. 6 is a flowchart showing another example method for manufacturing the touch sensor illustrated in FIGS. 1 to 3.

FIG. 7 is a cross-sectional view of the touch sensor illustrated in FIG. 6, in the process of being manufactured.

FIG. 8 is a cross-sectional view of an example configuration of a touch sensor according to a comparative example, with attention focused on its first wiring line and insulating layer.

FIG. 9 is a cross-sectional view of the touch sensor according to the comparative example illustrated in FIG. 8, in the process of being manufactured.

FIG. 10 is a cross-sectional view of an example configuration of the touch sensor according to one embodiment of the present disclosure.

FIG. 11 is a flowchart showing an example method for manufacturing the touch sensor illustrated in FIG. 10.

FIG. 12 is a cross-sectional view of an example configuration of a display device according to one embodiment of the present disclosure.

FIG. 13 is a cross-sectional view of an example configuration of the display device according to the embodiment of the present disclosure.

FIG. 14 is a flowchart showing an example method for manufacturing the display device illustrated in FIG. 12 or 13.

### DESCRIPTION OF EMBODIMENTS

### First Embodiment

### Planar Configuration

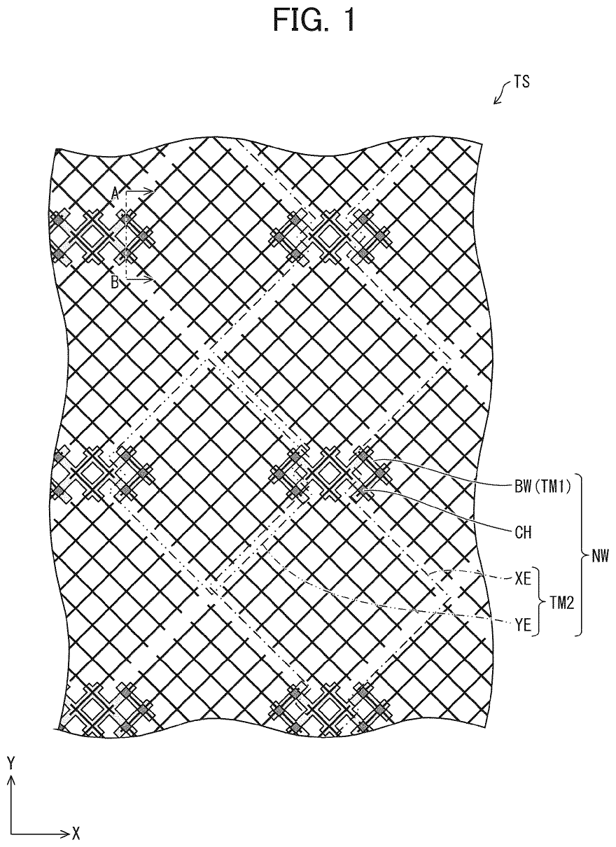

FIG. 1 is a plan view of an example configuration of a touch sensor according to one embodiment of the present disclosure. As illustrated in FIG. 1, a touch sensor TS includes a meshed wiring line NW, through which light can pass. The meshed wiring line NW includes the following: first wiring lines TM1 including bridge wiring lines BW; second wiring lines TM2 including X-electrodes XE and Y-electrodes YE; and contact holes CH. The X-electrodes XE and the Y-electrodes YE are net-shaped, so-called “meshed” electrodes.

The X-electrodes XE extend in a Y-direction and are provided in multiple rows in an X-direction. The Y-electrodes YE are formed in the same layer as the X-electrodes XE and are provided at a plurality of stages in the Y-direction. The adjacent Y-electrodes YE in the X-direction are connected to each other via a corresponding one of the bridge wiring lines BW. The bridge wiring line BW are formed in a layer separate from that of the X-electrodes XE and Y-electrodes YE, grade-cross with the X-electrodes XE, and are connected to the Y-electrodes YE via the contact holes CH.

### Cross-Sectional Configuration

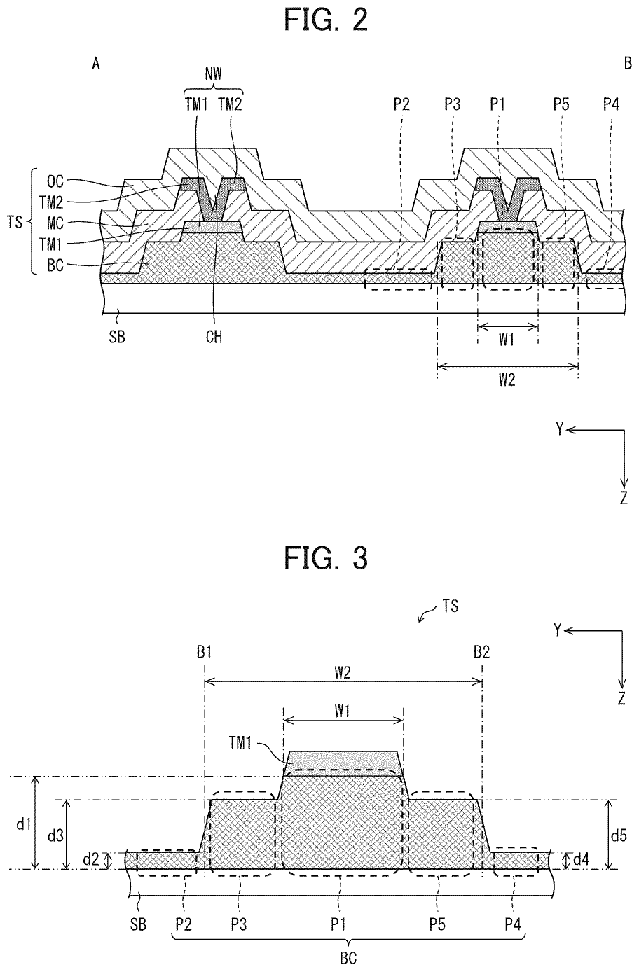

FIG. 2 is a cross-sectional view of the example configuration of the touch sensor illustrated in FIG. 1, and is a cross-sectional view taken along line A-B in FIG. 1. As illustrated in FIG. 2, the touch sensor TS is formed on a support SB and includes the following in the stated order from the lower layer to upper layer (i.e., from the bottom to top of FIG. 2): an insulating layer BC, the first wiring lines TM1, an insulating middle layer MC, the second wiring lines TM2, and an overcoat layer OC.

Each of the first wiring lines TM1 and second wiring lines TM2 is a part of the meshed wiring line NW. Each bridge wiring line BW is formed from the first wiring line TM1, and each X-electrode XE and each Y-electrode YE are formed from the second wiring line TM2. The bridge wiring line BW and the X-electrode XE are insulated from each other by the middle layer MC. The bridge wiring line BW and the Y-electrode YE are connected to each other by the contact hole CH.

FIG. 3 is a cross-sectional view of the example configuration of the touch sensor illustrated in FIGS. 1 and 2, with attention focused on the first wiring line and the insulating layer. For the sake of better understanding of the present disclosure, FIG. 3 omits layers over the first wiring line TM1. As illustrated in FIGS. 2 and 3, the insulating layer BC includes a first portion P1, a second portion P2, and a third portion P3 in cross-sectional view. The first portion P1 has a thickness d1. The second portion P2 has a thickness d2. The third portion P3 is positioned between the first portion P1 and the second portion P2, and has a thickness d3. The thicknesses d1, d2, and d3 establish 0<d1−d3<d3−d2. The first wiring line TM1 is positioned over the insulating layer BC, and overlaps the first portion P1 in plan view. The third portion P3 may be adjacent to the first portion P1 and the second portion P2.

The insulating layer BC may further include a fourth portion P4 and a fifth portion P5 in cross-sectional view. The fourth portion P4 is positioned opposite the second portion P2 with respect to the first portion P1, and has a thickness d4. The fifth portion P5 is positioned between the first portion P1 and the fourth portion P4, and has a thickness d5. The thicknesses d1, d4, and d5 establish 0<d1−d5<d5−d4. The fifth portion P5 may be adjacent to the first portion P1 and the fourth portion P4. The thicknesses d2, d3, d4, and d5 may establish d2=d4 and d3=d5.

Let the width of the first portion P1 be denoted as W1; in addition, let the distance from a boundary B1 between the second portion P2 and the third portion P3 to a boundary B2 between the fourth portion P4 and the fifth portion P5 be denoted as W2. The distance W2 may be double or more the width W1; that is, W2≥2×W1 may be established. When the second portion P2 and the third portion P3 are separated (for instance, when there is an inclination between the second portion P2 and the third portion P3), the boundary B1 may be a mid-line equally distant from the second portion P2 and third portion P3 in plan view. Likewise, when the fourth portion P4 and the fifth portion P5 are separated (for instance, when there is an inclination between the fourth portion P4 and the fifth portion P5), the boundary B2 may be a mid-line equally distant from the fourth portion P4 and fifth portion P5 in plan view.

As illustrated in FIG. 2, the second portion P2 corresponding to a certain first wiring line TM1 may be adjacent to or integral with the second portion P2 or fourth portion P4 corresponding to an adjacent first wiring line TM1. The fourth portion P4 corresponding to a certain first wiring line TM1 may be adjacent to or integral with the second portion P2 or fourth portion P4 corresponding to a different adjacent first wiring line TM1.

Each of the insulating layer BC, middle layer MC, and overcoat layer OC may contain an inorganic insulating material. The inorganic insulating material may include, for example, any one or more of silicon oxide, silicon nitride, and silicon oxynitride. Each of the first wiring line TM1 and second wiring line TM2 may contain a metal. The metal may include an alloy, and may have a monolayer structure or a multilayer structure.

The middle layer MC is insulating and is formed over the first wiring lines TM1. One or more contact holes CH are formed so as to penetrate the middle layer MC. The second wiring lines TM2 have a meshed shape, are formed over the first wiring lines TM1 and middle layer MC, and are connected, as appropriate, to the first wiring lines TM1 via the contact holes CH. The second wiring lines TM2 constitute the meshed X-electrodes XE and the meshed Y-electrodes YE (see FIG. 1). The overcoat layer OC is formed so as to cover the second wiring lines TM2.

### First Manufacturing Method

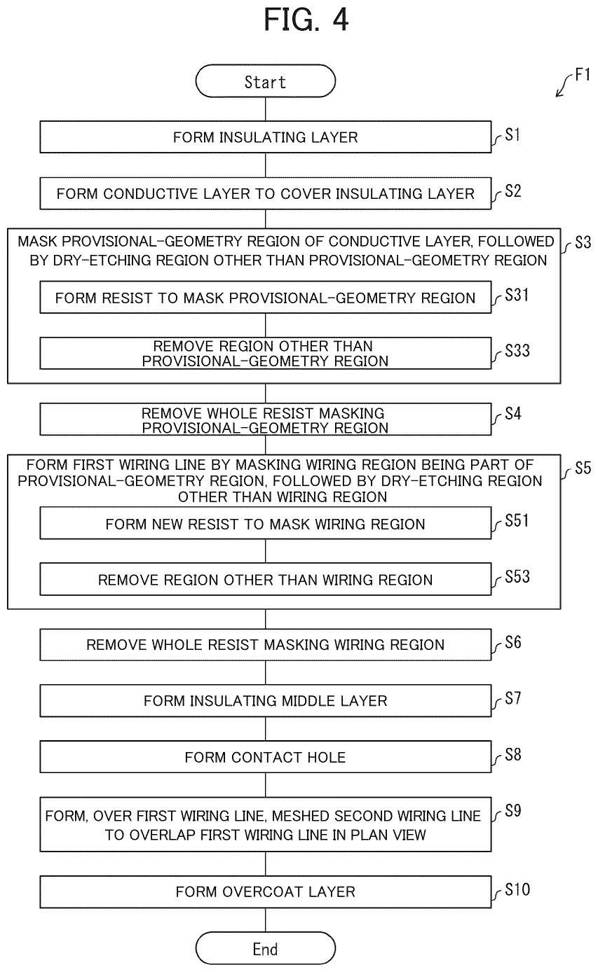

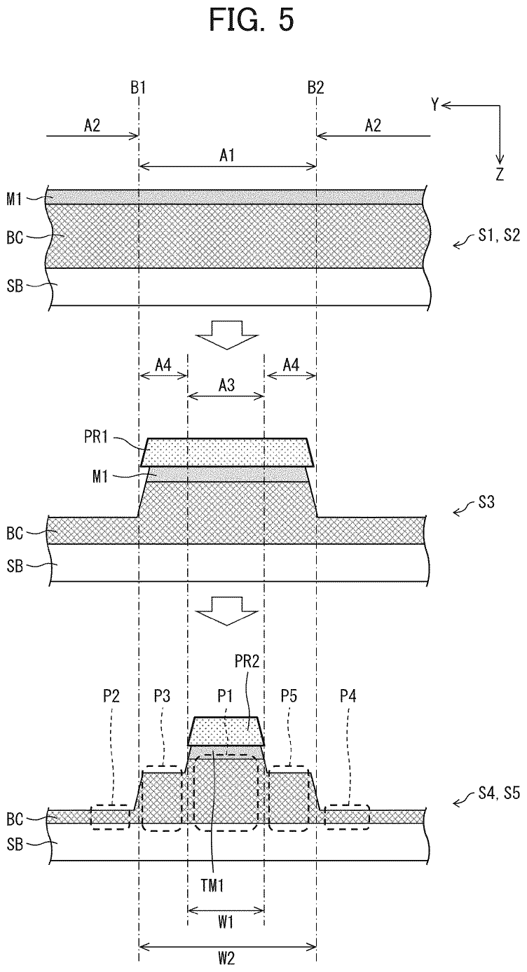

FIG. 4 is a flowchart showing an example method for manufacturing the touch sensor illustrated in FIGS. 1 to 3. FIG. 5 is a cross-sectional view of the touch sensor illustrated in FIG. 4, in the process of being manufactured. As shown in FIGS. 4 and 5, a method F1 for manufacturing the touch sensor TS includes Step S1, i.e., forming the insulating layer BC onto the support SB, and Step S2, i.e., forming a conductive layer M1 to cover the insulating layer BC. The next is Step S3, i.e., masking a provisional-geometry region A1 of the conductive layer M1, followed by dry-etching a region A2 other than the provisional-geometry region A1.

Step S3 includes Step S31, i.e., applying a resist PR1 onto the conductive layer M1 to be formed through photolithography such that the resist PR1 masks the provisional-geometry region A1 of the conductive layer M1. Step S31 is followed by Step S33, i.e., removing the region A2 other than the provisional-geometry region A1 of the conductive layer M1 through dry etching. Consequently, the provisional-geometry region A1 of the conductive layer M1 remains.

Step S3 is followed by Step S4, i.e., removing the whole of the resist PR1 masking the provisional-geometry region A1. The next is Step S5, i.e., forming the first wiring lines TM1 by masking a wiring region A3 of the conductive layer M1, followed by dry-etching a region A other than the wiring region A3. Here, the wiring region A3 is a part of the provisional-geometry region A1, and the region A4 other than the wiring region A3 is a part other than the wiring region A3 in the provisional-geometry region A1.

Step S5 includes Step S51, i.e., applying a resist PR2 onto the insulating layer BC and the conductive layer M1 to be formed through photolithography such that the resist PR2 masks the wiring region A3 of the conductive layer M1. Step S51 is followed by Step S53, i.e., removing the region A4 other than the wiring region A3 of the conductive layer M1 through dry etching. Consequently, the wiring region A3 of the conductive layer M1 remains as the first wiring lines TM1.

In Steps S3 and S5, the insulating layer BC under the conductive layer M1 can undergo dry etching. The insulating layer BC includes the first portion P1 to fifth portion P5. The first portion P1 is positioned under the wiring region A3 and does not undergo dry etching. The second portion P2 is and the fourth portion P4 are positioned in the region A2 other than the provisional-geometry region A1, and undergo dry etching twice. The third portion P3 is and the fifth portion P5 are positioned in the region A4 other than the wiring region A3, and undergo dry etching once. As earlier described, the third portion P3 is positioned between the first portion P1 and the second portion P2, and the fifth portion P5 is positioned between the first portion P1 and the fourth portion P4.

The depth of digging the insulating layer BC through dry etching is a so-called “dig amount”. The dig amount in Step S3 is prominently larger than the dig amount in Step S4. Hence, the foregoing relationships 0<d1−d3<d3−d2 and 0<d1−d5<d5−d4 are established (see FIG. 3). Further, the dig amount through the same dry etching is approximately constant although there are variations depending on positions. Hence, the foregoing relationships d2=d4 and d3=d5 can be established.

The resist PR1 masking the provisional-geometry region A1, and the resist PR2 masking the wiring region A3 contain an organic material. On the other hand. the insulating layer BC contains an inorganic material, and the conductive layer M1 contains a metal. After Step S4, i.e., removing the whole of the resist PR1 masking the provisional-geometry region A1, the new resist PR2 to mask the conductive layer M1 can be formed in Step S5.

The width of the resist PR1 masking the provisional-geometry region A1 may be double or more the width of the resist PR2 masking the wiring region A3. The width of the resist PR1 masking the provisional-geometry region A1 corresponds to the distance W2 from the boundary B1 between the second portion P2 and third portion P3 to the boundary B2 between the fourth portion P4 and fifth portion P5. The width of the resist PR2 masking the wiring region A3 corresponds to the width W1 of the first portion P1. Two adjacent provisional-geometry regions A1 in cross-sectional view are separated from each other through the dry etching in Step S33. Thus, the width of the resist PR1 masking the provisional-geometry region A1 is smaller than the sum of the width of the first wiring line TM1 and the distance between the two adjacent first wiring lines TM1.

Step S5 is followed by Step S6, i.e., removing the whole of the resist PR2 masking the wiring region A3. The next is Step S7, i.e., forming the insulating middle layer MC over the first wiring lines TM1, followed by Step S8, i.e., forming the contact holes CH penetrating the middle layer MC. The next is Step S9, i.e., forming, over the middle layer MC, the second wiring lines TM2 having a meshed shape to overlap the first wiring lines TM1 in plan view. In Steps S8 and S9, the contact holes CH and the second wiring lines TM2 are each formed such that the Y-electrode YE of the second wiring line TM2 is appropriately connected to the bridge wiring line BW of the first wiring line TM1 via the contact hole CH (see FIG. 1). The next is Step S10, i.e., forming the overcoat layer OC to cover the second wiring line TM2.

### Second Manufacturing Method

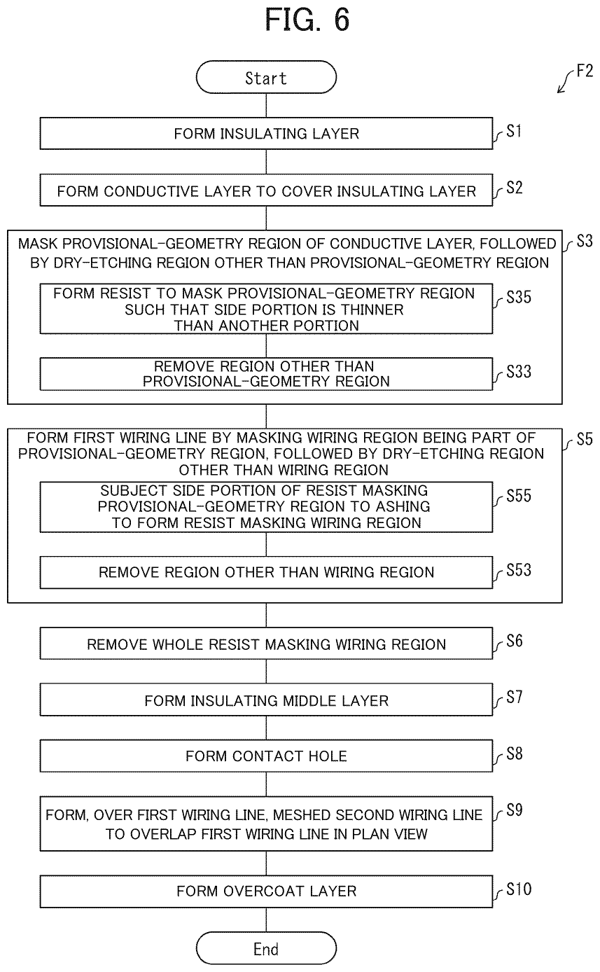

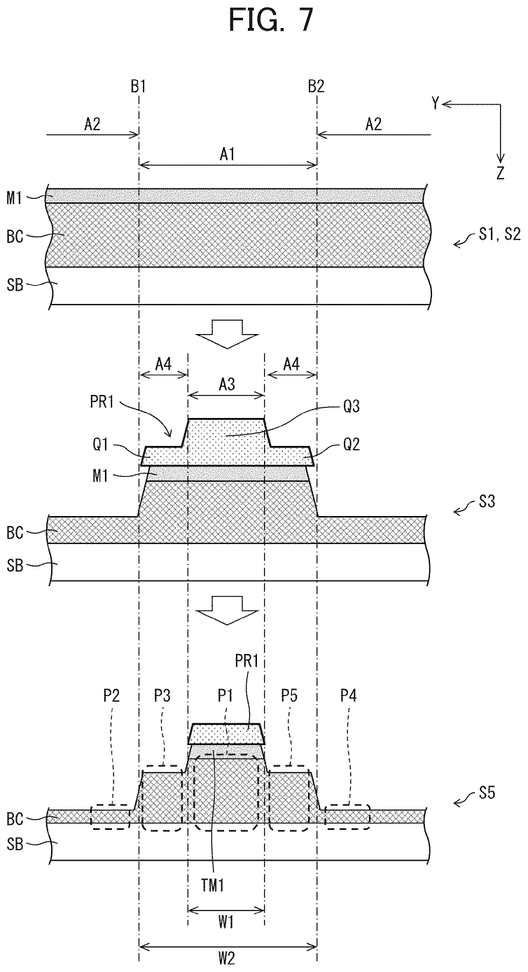

FIG. 6 is a flowchart showing another example method for manufacturing the touch sensor according to this embodiment. FIG. 7 is a cross-sectional view of the touch sensor illustrated in FIG. 6, in the process of being manufactured. For the sake of simple description, process steps similar to those in the manufacturing method F1 shown in FIGS. 4 and 5 will not be described. As shown in FIGS. 6 and 7, in a manufacturing method F2, Steps S1 and S2 are performed firstly, followed by Step S3.

Step S3 includes Step S35, i.e., forming the resist PR1 such that the resist PR1 masks the provisional-geometry region A1 of the conductive layer M1, and that side portions Q1 and Q2 of the resist PR1 are thinner than another portion Q3 of the same. In Step S35, the side portions Q1 and Q2 are formed through halftone exposure or graytone exposure for instance, and the other portion Q3 is formed through normal light exposure or normal light blocking for instance. Here, the side portions Q1 and Q2 correspond to the region A4 other than the wiring region A3, and the other portion Q3 corresponds to the wiring region A3. Step S33 is then performed.

Step S3 is followed by Step S5. Step S5 includes Step S55, i.e., removing the side portions Q1 and Q2 of the resist PR1 masking the provisional-geometry region A1, to mask the wiring region A3. Here, the side portions Q1 and Q2 may be removed through ashing. In addition, the upper part of the other portion Q3 of the resist PR1 may be also removed. In other words, the lower part of the other portion Q3 may be the resist PR1 for masking the wiring region A3. Step S53 is then performed.

Step S5 is followed by Steps S6 through Step S9 sequentially, followed by Step S10.

### Comparative Example

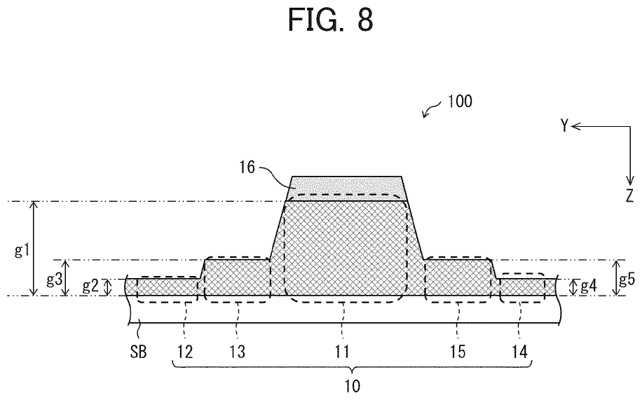

FIG. 8 is a cross-sectional view of an example configuration of a touch sensor according to a comparative example, with attention focused on its first wiring line and insulating layer. For the sake of better understanding of the present disclosure, FIG. 8 omits layers over first wiring lines 16. As illustrated in FIG. 8, a touch sensor 100 according to the comparative example includes the following: an insulating layer 10 including a first portion 11 through a fifth portion 15; and the first wiring lines 16 positioned over the insulating layer 10, and each overlapping the first portion 11 in plan view.

The first portion 11 in the comparative example has a thickness g1. The second portion 12 has a thickness g2. The third portion 13 is positioned between the first portion 11 and the second portion 12, and has a thickness g3. The fourth portion 14 is positioned opposite the second portion 12 with respect to the first portion 11, and has a thickness g4. The fifth portion 15 is positioned between the first portion 11 and the fourth portion 14, and has a thickness g5. The thicknesses g1 through g5 establish 0<g3−g2<g1−g3 and 0<g5−g4<g1−g5.

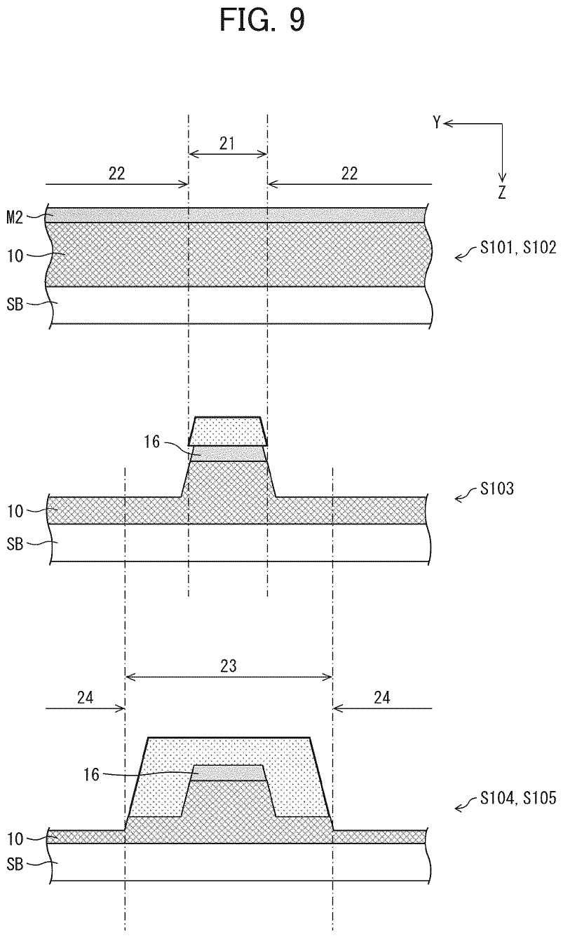

FIG. 9 is a cross-sectional view of the touch sensor according to the comparative example illustrated in FIG. 8, in the process of being manufactured. The first process step is Step S101, i.e., forming the insulating layer 10 onto the support SB, followed by Step S102, i.e., forming a conductive layer M2 to cover the insulating layer 10. The next is Step S103, i.e., forming the first wiring line 16 by masking a wiring region 21 of the conductive layer M2 with a resist, followed by dry-etching a region 22 other than the wiring region 21. Here, the first wiring line 16 corresponds to the wiring region 21 of the conductive layer M2.

The next is Step S104, i.e., removing the whole of the resist masking the wiring region 21. The next is Step S105, i.e., masking, with a new resist, a cover region 23 including the first wiring line 16 and its surroundings, followed by dry-etching a region 24 other than the cover region 23 in the insulating layer 10, to remove residues and other things of the conductive layer M2. The dig amount through the dry etching in the first time in Step S103 is prominently larger than the dig amount through the dry etching in the second time in Step S105. Hence, the foregoing relationships 0<g3−g2<g1−g3 and 0<g5−g4<g1−g5 are established.

The next is removing the whole of the resist masking the cover region 23, to sequentially form, as appropriate, a middle layer (corresponding to the middle layer MC), a contact hole (corresponding to the contact hole CH), a second wiring line (corresponding to the second wiring line TM2), and an overcoat layer (corresponding to the overcoat layer OC).

### Comparison With Comparative Example

The area ratio of the conductive layer M1 to be removed through the first dry etching, which is performed in Step S3 in the manufacturing method according to the present disclosure, is smaller than the area ratio of the conductive layer M2 to be removed through the first dry etching, which is performed in Step S103 in the manufacturing method according to the comparative example. For example, when the area ratio of the first wiring line TM1 to the conductive layer M1 according to the present disclosure stands at about 5%, and the width W2 of the provisional-geometry region A1 doubles the width W1 of the wiring region A3, the area ratio of the conductive layer M1 to be removed through the first dry etching stands at about 90%. On the other hand, when the area ratio of the first wiring line 16 to the conductive layer M2 according to the comparative example stands at about 5%, the area ratio of the conductive layer M2 to be removed through the first dry etching stands at about 95%. For the sake of simplicity, the influence on the area due to the wiring-line intersection and their ends is ignored.

The manufacturing method according to the present disclosure can reduce the time of the first dry etching, because the removal area ratio is smaller than that in the comparative example. The area ratio affects the time that is required for the dry etching in a nonlinear manner. Thus, even with the difference between 95% and 90%, or a smaller difference, the dry-etching time can be reduced significantly. This time reduction can reduce variations in optimum etching time for the conductive layer M1, and can thus reduce the over-etching time in a region where the etching rate is high. Consequently, the amount of film loss of the insulating layer can be reduced, and residues of the conductive layer M1 can be reduced.

This time reduction can reduce side-etching for the conductive layer M1, and can thus reduce a side shift in the region where the etching rate is high. This can reduce width narrowing of the first wiring line TM1, and breakage in the first wiring line TM1.

In the comparative example, the dry-etching time was shortened in order to reduce over-etching and side-etching; accordingly, the conductive layer M2 was not removed completely, increasing the conductive layer M2 remaining between the first wiring lines 16. In the present disclosure on the other hand, the conductive layer M1 remaining between the first wiring lines TM1 is less likely to increase, because the optimal etching time varies to a small extent.

The manufacturing method according to the present disclosure includes two-time dry etching for forming the first wiring lines TM1. Accordingly, when compared with a manufacturing method in which dry etching is performed only once, the manufacturing method of the present disclosure offers the conductive layer M1 whose residues are less likely to remain between the first wiring lines TM1, thereby reducing an electrical short circuit between the first wiring lines TM1.

### Second Embodiment

Another embodiment of the present disclosure will be described. It is noted that for convenience in description, components having the same functions as those of the components described in the foregoing embodiment will be denoted by the same signs, and that their descriptions will not be repeated.

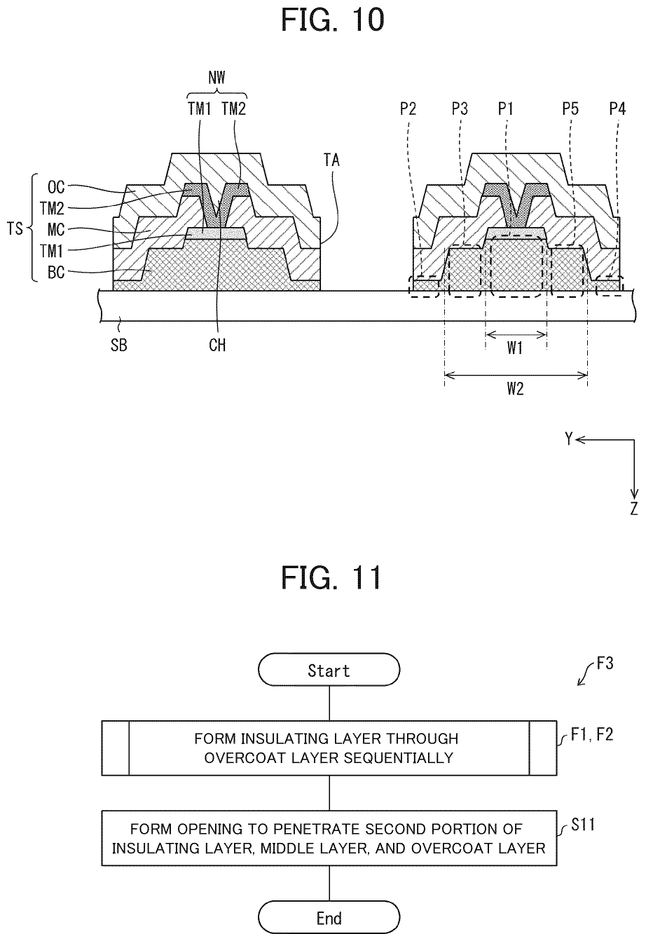

FIG. 10 is a cross-sectional view of an example configuration of the touch sensor according to one embodiment of the present disclosure. As illustrated in FIG. 10, the touch sensor TS is formed on the support SB and includes the following in the stated order from the lower layer to upper layer (i.e., from the bottom to top of FIG. 10): the insulating layer BC; the first wiring lines TM1; the middle layer MC; the second wiring lines TM2; and the overcoat layer OC. The touch sensor TS further includes an opening TA. The opening TA penetrates the second portion P2 and/or fourth portion P4 of the insulating layer BC, and penetrates the middle layer MC and the overcoat layer OC.

FIG. 11 is a flowchart showing an example method for manufacturing the touch sensor illustrated in FIG. 10. As shown in FIG. 11, in a method F3 for manufacturing the touch sensor TS according to this embodiment, the insulating layer BC through the overcoat layer OC are sequentially formed firstly by using the foregoing manufacturing method F1 or manufacturing method F2 according to the first embodiment. The next is Step S11, i.e., forming the opening TA so as to penetrate the second portion P2 and/or fourth portion P4 of the insulating layer BC, and to penetrate the middle layer MC and the overcoat layer OC.

### Third Embodiment

Another embodiment of the present disclosure will be described.

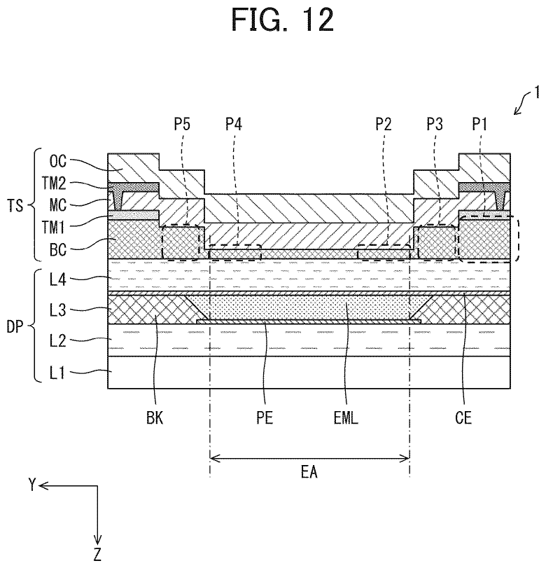

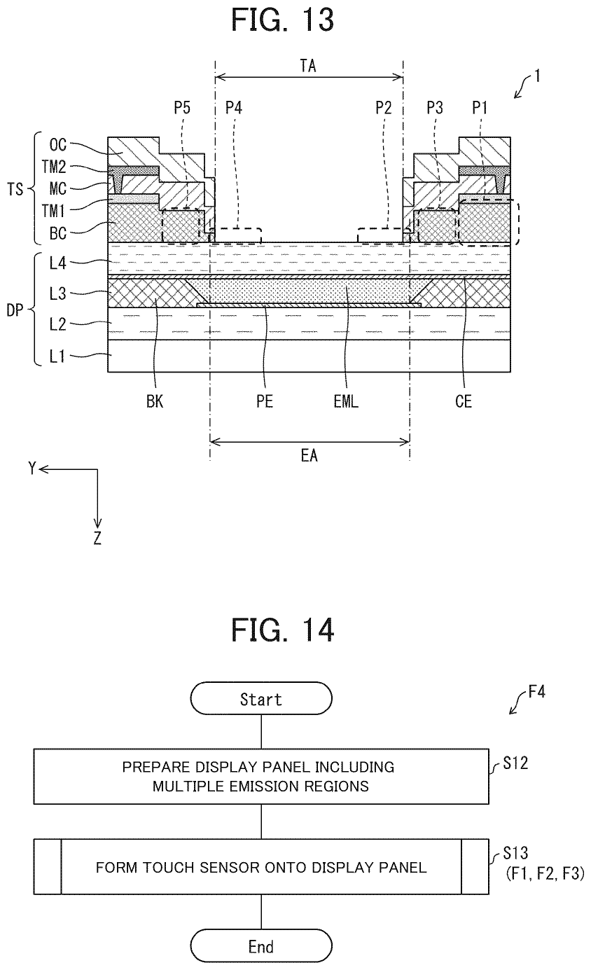

FIGS. 12 and 13 are each cross-sectional views of example configurations of a display device according to one embodiment of the present disclosure. As illustrated in FIGS. 12 and 13, a display device 1 includes a display panel DP, and the touch sensor TS on the display panel DP. The touch sensor TS may have the foregoing configuration according to the first or second embodiment, or may have a configuration with various changes or modifications added to the foregoing configuration according to the first or second embodiment.

The display panel DP may include the following by way of example: a support substrate L1; a circuit layer L2 including a pixel circuit positioned over the support substrate L1; a light-emitting element layer L3 including light-emitting elements positioned over the circuit layer L2; and a sealing layer L4 positioned over the light-emitting element layer L3. The light-emitting element layer L3 includes the following: a pixel electrode PE; a bank BK covering the edge of the pixel electrode; a common electrode CE facing the pixel electrode PE; and an emission layer EML positioned between the pixel electrode PE and the common electrode CE. The insulating layer BC may be formed on the sealing layer L4.

The display panel DP may include a plurality of emission regions EA. The emission regions EA may correspond to the pixel electrodes PE, and each may overlap the corresponding pixel electrode PE in plan view. The first wiring line TM1 may overlap a gap of the emission region EA in plan view, and the emission region EA may overlap the second portion P2 and/or fourth portion P4 of the insulating layer BC in plan view. When the touch sensor TS includes the opening TA as illustrated in FIG. 13, the emission region EA may overlap the opening TA in plan view.

FIG. 14 is a flowchart showing an example method for manufacturing the display device illustrated in FIG. 12 or 13. As shown in FIG. 14, a method F4 for manufacturing the display device 1 includes the following: Step S12, i.e., preparing the display panel DP having the plurality of emission regions EA; and Step S13, i.e., forming the touch sensor TS onto the display panel DP by using the method for manufacturing the touch sensor TS according to the present disclosure. The method for manufacturing the touch sensor TS in Step S13 may be any one of the foregoing manufacturing methods F1 to F3 according to the first or second embodiment, or may be a manufacturing method with various changes or modifications added to the foregoing manufacturing methods F1 to F3 according to the first or second embodiment.

The present disclosure is not limited to the foregoing embodiments. Various modifications can be made within the scope of the claims. An embodiment that is obtained in combination as appropriate with the technical means disclosed in the respective embodiments is also encompassed within the technical scope of the present disclosure. Furthermore, combining the technical means disclosed in the respective embodiments can form a new technical feature.

1. A touch sensor comprising:
an insulating layer including a first portion having a thickness d1, a second portion having a thickness d2, and a third portion positioned between the first portion and the second portion, and having a thickness d3, wherein 0<d1−d3<d3−d2 is established; and
a first wiring line positioned over the insulating layer, and overlapping the first portion in a plan view.

2. The touch sensor according to claim 1, wherein the third portion is adjacent to the first portion and the second portion.

3. The touch sensor according to claim 1, wherein
the insulating layer includes a fourth portion positioned opposite the second portion with respect to the first portion, and having a thickness d4, and includes a fifth portion positioned between the first portion and the fourth portion, and having a thickness d5, and
0<d1−d5<d5−d4 is established.

4. The touch sensor according to claim 3, wherein d2=d4 and d3=d5 are established.

5. The touch sensor according to claim 3, wherein W2≥2×W1 is established, where W1 denotes a width of the first portion, and where W2 denotes a distance from a boundary between the second portion and the third portion to a boundary between the fourth portion and the fifth portion.

6. (canceled)

7. The touch sensor according to claim 1, comprising:
a middle layer being insulating and formed over the first wiring line; and
a second wiring line having a meshed shape and connected to the first wiring line via a contact hole formed in the middle layer.

8. The touch sensor according to claim 7, comprising an overcoat layer covering the

9. The touch sensor according to claim 8, comprising an opening penetrating the overcoat layer and the second portion.

10. A display device comprising:
a display panel; and
the touch sensor according to claim 1.

11. A method for manufacturing a touch sensor, comprising:
forming an insulating layer;
forming a conductive layer to cover the insulating layer;
masking a provisional-geometry region of the conductive layer with a resist, followed by dry-etching a region other than the provisional-geometry region; and
forming a first wiring line by masking, with a resist, a wiring region being a part of the provisional-geometry region, followed by dry-etching a region other than the wiring region.

12. The method for manufacturing the touch sensor according to claim 11, wherein
the insulating layer includes
a first portion positioned under the wiring region, and that does not undergo dry etching,
a second portion positioned under the region other than the provisional-geometry region, and that undergoes dry etching twice, and
a third portion positioned between the first portion and the second portion, and that undergoes dry etching once.

13. The method for manufacturing the touch sensor according to claim 12, wherein 0<d1−d3<d3−d2 is established, where d1 denotes a thickness of the first portion, where d2 denotes a thickness of the second portion, and where d3 denotes a thickness of the third portion.

14. (canceled)

15. The method for manufacturing the touch sensor according to claim 11, comprising, after the dry-etching of the region other than the provisional-geometry region, removing a whole of the resist masking the provisional-geometry region.

16. The method for manufacturing the touch sensor according to claim 11, comprising, after the dry-etching of the region other than the provisional-geometry region, removing a side portion of the resist masking the provisional-geometry region.

17. The method for manufacturing the touch sensor according to claim 16, wherein the side portion is thinner than another portion.

18. The method for manufacturing the touch sensor according to claim 17, wherein the side portion is formed through halftone exposure or graytone exposure.

19. The method for manufacturing the touch sensor according to claim 11, wherein a width of the resist masking the provisional-geometry region is double or more a width of the resist masking the wiring region.

20. The method for manufacturing the touch sensor according to claim 11, comprising:
forming, over the first wiring line, a middle layer being insulating; and
forming, over the middle layer, a second wiring line to overlap the first wiring line in a plan view, the second wiring line having a meshed shape.

21. A method for manufacturing a display device, comprising:
preparing a display panel including a plurality of emission regions; and
forming a touch sensor onto the display panel by using the method for manufacturing the touch sensor according to claim 11.

22. The method for manufacturing the display device according to claim 21, wherein the first wiring line overlaps a gap of the plurality of emission regions in a plan view.
